(19) United States
(12) Patent Application Publication
(10) Pub. No.: US 2007/0073461 A1
(43) Pub. Date: Mar. 29, 2007

(54) Vehicle suspension control

(76) Inventor: Nicholas Albert William Fielder, Kalamunda (AU)

Correspondence Address: GOTTLIEB RACKMAN & REISMAN PC, 270 MADISON AVENUE, 8TH FLOOR, NEW YORK, NY, 100160601, US

(21) Appl. No.: 10/575,608

(22) PCT Filed: Oct. 15, 2004
(86) PCT No.: PCT/AU04/01427

§ 371 Date: Jul. 24, 2006

(30) Foreign Application Priority Data
Oct. 17, 2003 (AU) 2003905717

(51) Int. Cl. B60G 17/018

(52) U.S. Cl. 701/37

(57) ABSTRACT

A vehicle suspension control for a vehicle having each wheel (11) supported from the chassis of the vehicle trough a fluid operated extension element (13, 19), the control comprising a controller (27), a plurality of sensors (21, 23, 25, 27, 30, 32), a fluid flow controller (29), a first sensor (21) adapted to sense the relative position between the wheel (11) and the chassis and provide a first output to the controller, a second sensor (23) adapted to sense the pressure of the fluid in each extension element (13, 19) and provide a second output to the controller (27) adapted to receive the output from each of the sensors (21, 23) at each wheel, process the outputs and provide a wheel output to the fluid flow controller (29) for each wheel, the force applied by the extension elements (13, 19) between the chassis and wheels will maintain the attitude of the chassis substantially constant relative to a plane.

### FIELD OF THE INVENTION

This invention relates to a vehicle suspension control which is intended to control the suspension system of vehicle.

### BACKGROUND ART

Conventional vehicle suspension systems are generally passive and usually comprise metallic coil springs supplemented by hydraulic shock absorbers that provide a damping function. The suspension systems are generally used to smooth out vehicle ride action over rough or uneven terrain. In general the vehicle follows the contours of the road and as a result the attitude or departure of the vehicle chassis from the horizontal is a function of the locations of the four wheels supporting the chassis. Therefore if a wheel drops into a pot hole or rides up on a high point then the vehicle will tend to follow the same path. The performance of the conventional style of suspension can be optimised for either the road (smooth terrain) or off-road (uneven terrain) but not both. Off road the vehicle performance is generally compromised and safe effective speeds are constrained because of the nature of the suspension system.

### DISCLOSURE OF THE INVENTION

The present invention is directed to an active suspension system which utilises sensors associated with the vehicle and a controller which reacts to the sensor value and provides signals to suspension units of the vehicle in order to provide positive control over chassis dynamics.

Throughout the specification the term fluid shall be take to include compressible fluids such as gaseous fluids.

Accordingly the invention resides in a vehicle suspension control for a vehicle in which each wheel is supported from the chassis of the vehicle through a fluid operated extension element which can control a degree of relative displacement between the wheel and the chassis, the extension element enabling the resilient relative movement between the vehicle and chassis said control comprising:
a controller;
a plurality of sensors associated with each wheel of the vehicle;
a fluid flow controller comprising a fluid flow delivery means and a fluid exhaust means associated with each extension element;
a first sensor adapted to sense the relative position between the wheel and the chassis and provide a first output tot the controller;
a second sensor adapted to sense the pressure of the fluid in each extension element and provide a second output to the controller;
   the controller adapted to receive the output from each of the sensors at each wheel, process the outputs and provide a wheel output to the fluid flow controller for each wheel to control the delivery of fluid or the exhaustion of fluid from respective extension element whereby the fluid pressure within each extension element is varied in order that the force applied by the extension elements between the chassis and wheels will maintain the attitude of the chassis to a plane substantially constant.

According to a preferred feature of the invention the plane comprises the general plane of the ground being traversed.

According to a preferred feature of the invention the wheel output for each wheel comprises a signal derived from the first output of each of the sensors of the respective wheel together with the first output from the sensors of adjacent wheels. According to one embodiment the adjacent wheels comprise a wheel which is most adjacent along the transverse axis of the chassis and a wheel which is most adjacent along a longitudinal axis of the chassis.

According to a preferred feature of the invention the controller comprises a third sensor is provided on the vehicle and is adapted to provide a third output which is representative of the movement of the chassis in the vertical sense over the ground relative to free space. According to a preferred feature of the invention the controller comprises a fourth sensor adapted to provide a fourth output representative of the lateral acceleration of the chassis. According to a preferred feature of the invention the controller comprises a fifth sensor adapted to provide a fifth output representative of the steering angle of the steering wheels. According to a preferred feature of the invention the controller comprises a sixth sensor adapted to provide a sixth output representative of the speed of the chassis over the ground.

According to a preferred feature of the invention the wheel output signal for a wheel comprises a summation of the first output from the first sensor of the respective wheel, the first output from the first sensor of each of the adjacent wheels, the second output from the second sensor of the respective wheel. According to a preferred feature of the invention the weighting applied to the first output of the respective wheel and the first output of each of the adjacent wheels is of the order of 2:1. According to a further preferred feature of the invention the controller includes an adjustable control connected to the controller which provides a control signal which can be adjusted to vary the weighting or bias applied to the first outputs from each of the first sensors in determining the wheel output to control the permitted degree of change in attitude of the chassis relative to the plane. According to a preferred embodiment of the invention the summation of the first signals is biased by the control signal before the second signal is included to produce a resultant signal. According to a preferred feature of the invention the weighting applied between the resultant signal and the second signal in deriving the wheel output is of the order of 10:1.

According to a preferred feature of the invention the adjustable control provides a control signal comprising a pitch control, a roll control and a height control component. According to a preferred feature of the invention the control signal comprises a first control signal which is set to control the height of the chassis relative to the wheels. According to a preferred feature of the invention the control signal comprises a second control signal which is set to control the permitted degree of roll of the chassis relative to the plane. According to a preferred feature of the invention the control signal comprises a third control signal which is set to control the permitted degree of variation of the pitch of the chassis relative to the plane.

According to a preferred feature of the invention the controller can include a gyroscopic device adapted to provide a signal indicative of a datum plane. According to a preferred feature of the invention the datum plane can be varied in its inclination

According to a further aspect of the invention the invention resides in a damping control for a vehicle comprising a fluid operated damper between each wheel and the chassis each damper being capable of providing a variable degree of damping, each damper being controlled by a damper control, the control comprising a set of first sensors which provide a first output indicative of the relative position between the wheels and the chassis and a set of third sensors adapted to provide a third output indicative of the relative motion between the wheels and the chassis, the control further comprising a second control which receives the signal from the first and third sensors for each wheel, said second control providing a damping output to the damper control of each damper to vary the degree of damping applied by the damper in proportion to the third output wherein the signal from the third sensor is allowed or inhibited by the relative motion output of the first sensors.

The effect of the damper control is such that if wheels are moving toward the chassis and the chassis is experiencing upwards acceleration then no signal is provided to the damper, however if the wheels are moving away from the chassis and the chassis is experiencing upwards acceleration then the signal to the damper is enabled. In the event that the wheels are moving toward the chassis and the chassis is experiencing downwards acceleration then the signal to the damper is enabled, however if the wheels are moving away from the chassis and the chassis is experiencing downwards acceleration then no signal is provided to the damper.

According to a preferred embodiment of the invention the chassis will maintain a constant attitude relative to the general ground plane.

According to a preferred embodiment of the invention the chassis will maintain a constant attitude relative to the horizontal.

According to a preferred feature of the invention the invention comprises a vehicle suspension control of the form described above together with a damper control of the form described above where the first sensor, the first output, the third sensor and the third output of the vehicle suspension control comprise the first sensor, the first output, the third sensor and the third output of the damper control.

According to a further aspect of the present invention there is provided a suspension system for a vehicle comprising a chassis and at least front and rear axles supporting wheels for rotational movement of the vehicle wherein said suspension system comprises resilient support members to provide resilient support for each of said wheels from said chassis, said resilient support members being controllable by a controller to vary relative displacement between each said wheel and said chassis and wherein said controller receives control signals from sensors operatively associated with said suspension system to provide signals indicative of relative displacement between each said wheel and said chassis and wherein in response to said signals said controller provides a control signal to each said resilient support member to thereby control said relative displacement between each said wheel and said chassis so as to maintain the attitude of said chassis substantially parallel with a plane of average axle articulation wherein said plane of average axle articulation comprises a plane bisecting an included angle formed between first and second planes wherein said first plane is a plane passing through said front axle of said vehicle and said second plane is a plane passing through said rear axle of said vehicle.

Preferably said control signal provided to each said resilient support member is derived from the relative displacement of a respective wheel associated with a resilient support member and relative displacement of adjacent wheels associated with adjacent resilient support members. Preferably said control signal is derived from the summation of the relative displacement of a respective wheel and the displacement of adjacent wheels. Preferably said respective wheel and said adjacent wheels have a weighting in the ratio of 2:1, said adjacent wheels each having said weighting of 1.

Preferably said system comprises at least one sensor adapted to output a lateral acceleration signal indicative of said vehicles lateral acceleration and said controller controlling said relative displacement of said wheels from said chassis in response to said lateral acceleration signal so as to compensate for chassis roll and thereby maintain said attitude of said chassis parallel with said plane of average axle articulation.

Preferably said system is adapted to provide vertical acceleration signals indicative of each said wheels vertical acceleration and said controller controlling said relative displacement of said wheels, from said chassis in response to each said vertical acceleration so as to maintain said attitude of said chassis parallel with said plane of average axle articulation.

Preferably said comprises resilient support members adapted to accommodate a fluid to provide said resilient support and the system actuates said resilient support members by supplying fluid under pressure and said system further comprises sensors to output to said controller signals derived from fluid pressure in each said resilient member and said system controlling said fluid pressure in each said resilient member to thereby maintain substantially equal pressures in each said resilient support members.

Preferably said relative displacement and said fluid pressure have a weighting ratio in the range of 20:1 to 5:1 where said pressure signal assumes said weighting of 1. Preferably the weighting ratio is 10:1 such that the pressure signal assumes said weighting of 1. In this way any error signal utilised by said controller in generating signals for actuating a resilient support member for a particular wheel is dominated by the relative displacement aspect of the error signal until this relative displacement error is in the order of 10% of its set point whereupon the error component attributable to the pressure signal is of a similar proportion to the error due to the relative displacement error.

The invention will be more fully understood in the light of the following description of one specific embodiment.

### BRIEF DESCRIPTION OF THE DRAWINGS

The description is made with reference to the accompanying drawings of which;

FIG. 1 schematic illustration of the control provided for an air spring and associated damper for a vehicle in accordance with the first embodiment; and

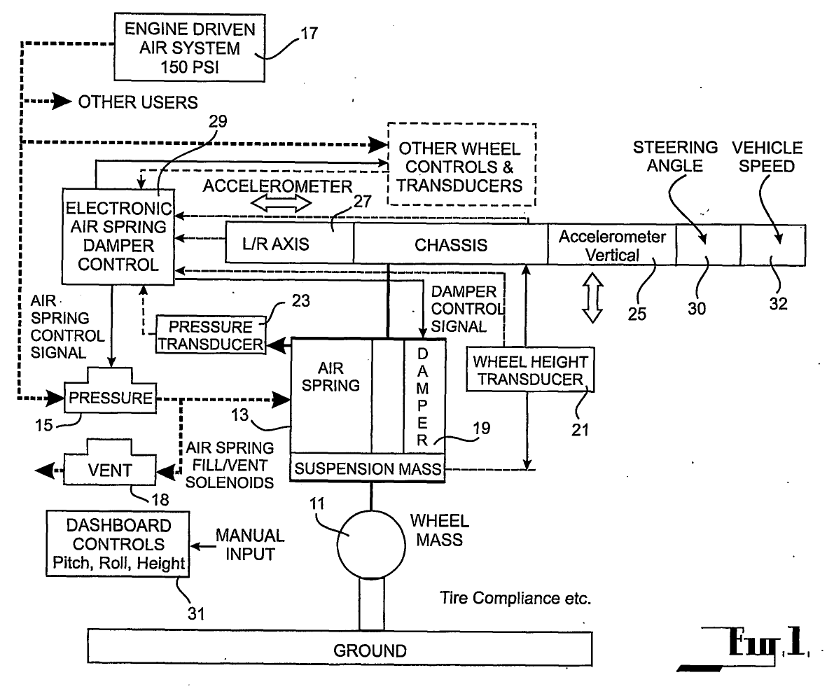

FIG. 2 is a logic circuit illustrating the operation of the suspension system according to the first embodiment.

### DETAILED DESCRIPTION OF SPECIFIC EMBODIMENT

The embodiments provide an active suspension system that generally maintains the attitude of a vehicle's chassis substantially parallel with a plane of average axle articulation.

Vehicle suspension systems may be regarded as either active or passive. A typical passenger vehicle has a passive suspension system in which the response to system inputs is dictated by the mechanical properties of the system's springs and dampers. An active suspension systems provides the system with intelligence in the form of sensors, controllers and actuators and attempt to provide response characteristics dictated by control system intelligence.

Active control systems may be classed as semi-active and fully active. Semi-active control systems utilise both active and passive elements to respond to system inputs. Typically in such systems the passive control compensates for higher frequency inputs such as those associated road surface roughness and the active control compensates for low frequency inputs such as pot holes, bumps and turning into corners. Fully active control systems utilise controllers that control resilient support members to compensate for both high frequency and low frequency inputs. This requires control system algorithms of greater complexity than those provided in semi-active control systems.

Axle articulation occurs where an axle is rotated about the longitudinal axis of the vehicle (e.g. when the left wheel is displaced toward or away from the chassis to a greater or lesser extent than the right wheel). The front and rear axles of the vehicle may be articulated to differing extents at point in time, particularly where a vehicle is being driven under off road conditions. Hence it is possible for the front axle to slope downwardly from left to right at the same time as the rear axle slopes downwardly from right to left.

A plane of average axle articulation is a longitudinal plane relative to the vehicle chassis that bisects an included angle between a longitudinal first plane relative to the vehicle chassis passing through the front axle of a vehicle and a longitudinal second plane relative to the vehicle chassis passing through a rear axle of a vehicle. Therefore the plane of average axle articulation can correspond with the average ground plane seen by the wheels of a vehicle at a particular point in time. The embodiments provide active or semi-active suspension systems that maintain the chassis of a vehicle parallel with the average ground plane seen by the wheels of the vehicle.

Where the front and rear axles have equal and opposite articulation the embodiments calculate the plane of average axle articulation to be horizontal. Hence the chassis is maintained substantially horizontal in the situation where the front and rear axles have equal and opposite articulation. This is because the plane bisecting the included angle between the planes that pass through the front and rear axles will be horizontal when the front and rear axles have equal and opposite articulation.

In addition the embodiments calculate the ground plane seen by each wheel of the vehicle from the relative displacement of a respective wheel and chassis and from the relative displacement of adjacent wheels. The weighting ratio of the respective wheel to the adjacent wheel is 2:1 where the adjacent wheels have a weighting of 1.

Furthermore the embodiments incorporate sensors providing signals indicative of lateral acceleration experienced by the vehicle. Lateral acceleration is typically experienced by a vehicle when turning through a corner. For a passive suspension system, the degree of chassis roll about the vehicles longitudinal axis is typically proportional to the extent of lateral acceleration experienced by the vehicle as it turns through the corner. Chassis roll in a passive suspension system causes the springs on one side of the vehicle to compress at the same time as the springs on the other side extend. The embodiments control the resilient members so as to counteract the chassis roll.

In instances where the vehicle chassis incorporating the embodiments experience lateral acceleration and axle articulation simultaneously, then the chassis roll may cause the plane of average axle articulation, as viewed relative to the chassis, to vary from the plane that would be seen if the vehicle were only experiencing articulation. However the embodiments use one or more lateral acceleration signals to actuate resilient members and thereby counteract the chassis roll. As such, the one or more lateral acceleration signals enable the embodiments to maintain the chassis substantially parallel with the plane of average axle articulation even where the vehicle is simultaneously experiencing articulation and lateral acceleration.

The first embodiment is directed to an active suspension control for a vehicle in which the chassis is supported from a set of wheels through air springs 13 and associated dampers 19. The volume of the air springs can be varied by the injection or exhaustion of air into and out of the spring through suitable control valves 15 and 18 which are associated with each wheel and associated spring. The valve 15 is connected to a source 17 of compressed air. Valve 18 is vented to atmosphere. The valves are operable such that air can be injected from the source 17 into the air spring 13 or exhausted to atmosphere from the air spring through vent valve 18. The operation of the valves 15 and 18 is controlled from a controller 29.

Each damper 19 extends between the wheel and the chassis and is intended to control the relative resilient movement between the wheel and the chassis. Each damper is of the form whereby the damping action can be selectively controlled to enable the degree of damping which is applied to the motion between the chassis and wheel to be varied. The dampers are controlled from a damper control which is a part of the controller 29.

The suspension system according to the embodiment comprises utilisation of a plurality of sensors which provide an indication of the loading carried by each of the wheels, the relative position of the wheels with respect of the chassis, as well as the nature of the relative movement of the chassis with respect to free space whereby the output from each of the sensors can then be operated upon by the controller 27 in order to operate the control valves 15 and 18 as well as the damper control.

The sensors comprise a set of first sensors 21 (one for each wheel) which are able to measure the relative displacement between the respective wheel and the chassis to provide a first output indicative of the relative position of the wheel to either side of a desired position. In addition a set of second sensors 23 (one for each wheel) provides a second output which is indicative of the pressure of the air within the air spring of the suspension system for the respective wheel. A set of third sensors 25 (one for each wheel) provides a third output indicative of the rate of change (acceleration) of the chassis associated with such movement relative to free space.

A fourth sensing arrangement 27 is provided on the chassis and provides a fourth output which is a measure of the lateral acceleration of the chassis. A fifth sensing arrangement 30 is provided on the chassis and provides a fifth output representative of the steering angle. A sixth sensing arrangement 32 is provided on the chassis and provides a sixth output which is representative of the speed of the chassis over the ground. The outputs from the fourth, fifth and sixth sensors 27, 30 and 32 (i.e. the fourth, fifth and sixth outputs respectively provide pre-emptive signals that enable the controller 29 to anticipate potential changes in chassis attitudes during cornering situations

The outputs of each of the first, second, third fourth, fifth and sixth sensors are delivered to the controller 29.

In addition the embodiment incorporates a dashboard mounted adjustable control 31 which provides a control signal to the controller to enable a driver to preset the permitted degree of pitch, roll of the chassis relative to the general plane of the ground being traversed and chassis height desired by the driver. The control signal comprises three control signals, one for pitch control, one for roll control and one for height control which can each be varied separately. The adjustable control is able to be manually adjusted by the driver according to road driving conditions.

The controller 29 provides a wheel output to the control valves 15 and 18 of each air spring to cause it to vent air from the spring or alternatively admit compressed air from the source 17 of compressed air. The wheel output is derived from a summation of the first and second outputs which are received by the controller. In providing the wheel output for a respective wheel the first output from the respective and the first outputs of the most adjacent wheels (i.e. the wheel transversely opposite and the wheel longitudinally aligned with the respective wheel) are summed with a weighting of 50% for the respective wheel and 25% for the adjacent wheels. The Dashboard controls 31 giving desired vehicle attitude and height presets are then summed. The Second outputs 23 are then summed comparatively. Outputs 4, 5 & 6 are then summed to give an output to valves 15 and 18.

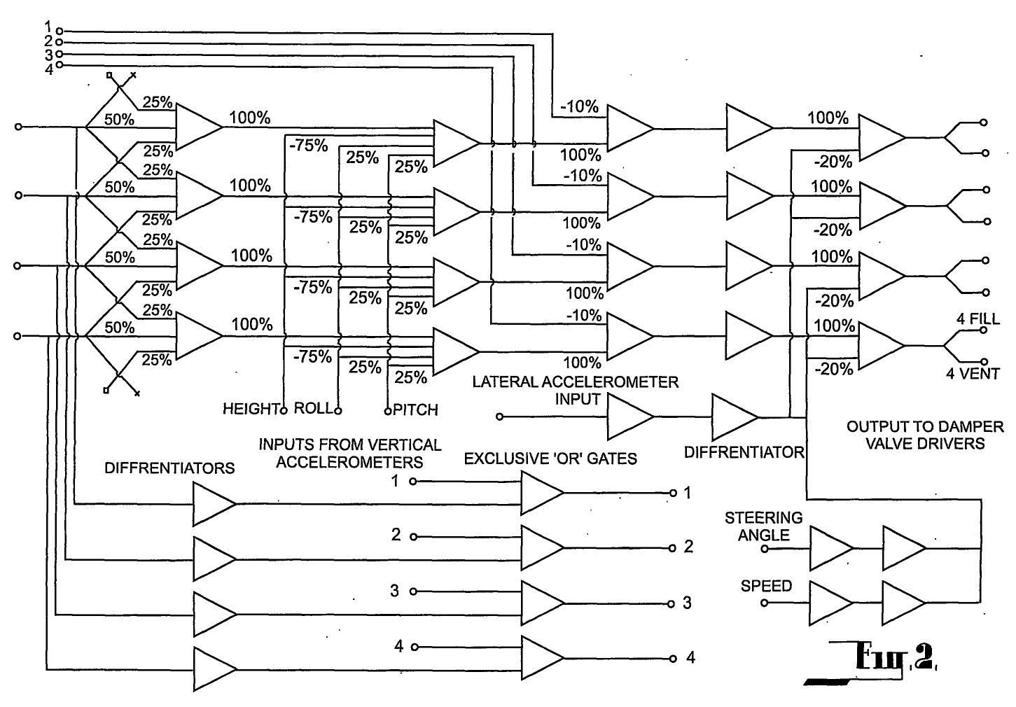

FIG. 2 illustrates the manner in which the signals are operated on by the controller whereby the first output of a wheel is delivered to the controller and is combined with the first output of the adjacent wheels and whereby the ratio of the weighting of the signals of the respective wheel to each of the adjacent wheel is 2:1. The summation of the first outputs signals is then further biased in accordance with the three set point control signals that allow an operator of the vehicle to set a desired chassis attitude. The set point control signals are height, roll and pitch and relative to the summation of the first outputs the weightings of the set point control signals is as follows:

| | |
|---|---|
| the summation of the first outputs | 100%; |
| the height control signal | 75%; |
| the roll control signal | +or−25%; |
| the pitch control signal | +or−25%. |

The resultant output for the respective wheel is then summed with the second output from the second sensor associated with each wheel whereby the ratio between the resultant output for each wheel to the second output for the respective wheel is 10:1 to produce a further output. The second output is a pressure signal indicative of pressure within the air springs. The signal that is summed with the pressure signal may be regarded as a height signal (i.e. it adjusts the relative displacement of each wheel relative to the chassis). The relative weighting of height signal to the pressure signal is 10:1 in the present embodiment though it may be within the range 5:1 to 20:1. The weighting of 10:1 means that the height control signal will dominate the pressure control signal until the height control signal represents an error from its desired setting of approximately 10%. When the height error is in this order then the height error and pressure signals will be of similar magnitude and as the height error continues to reduce to zero, the pressure signal will then dominate. Hence the system is biased to bring chassis attitude to within its desired setting over providing even pressure distribution across the vehicles wheels. The further output then has added thereto the fourth, fifth and sixth output from fourth, fifth and sixth sensors 27, 30 & 32 which measures the anticipated roll of the vehicle. As a result a wheel output is derived which is then delivered to the control valves 15 and 18 of the wheel to either allow the air spring to maintain its current pressure, to cause the spring to be vented or alternatively to inject compressed air into the spring. The effect of the control of the pressure in each air spring through the controller is such that the pressure in the springs (and thus the load) of all of the wheels is controlled to maintain the attitude of the chassis substantially constant relative to the general ground plane of the ground being traversed by the vehicle.

The control valves for each wheel utilises a pair of solenoid operated valves to either inject pressurised air into the spring or vent air from the spring. In providing the wheel output the controller modifies the finally derived signal through a time delay to ensure that the wheel output that is provided to the respective solenoids is in accordance with the operating characteristics (opening and closing rates of the solenoids) and to preclude the possibility of an overlapping of the operation of the solenoid valves for each spring.

In addition each spring is associated with a damper 19 which is capable of varying its damping characteristics dependent upon the direction of motion of the wheel relative to the chassis as well as the vertical acceleration of the chassis relative to free space. The control for the damper is effected through the controller 29 which provides a damper signal for each wheel which is derived from the first output of the first sensor 21 of the respective wheel and the third output from the third sensor 25 of each wheel whereby the first output is differentiated. The third output provides the signal output to the damper. The damper output is provided to the damper control only when the differentiated first output and the third output for each wheel are of opposite polarity. This means that a damping action above a residual damping action of the damper is only applied by the damper when the chassis and wheels are moving in opposite directions. This allows the damper to counteract momentum of the wheel and axle in the vertical direction and thereby prevent overshoot of the wheel relative to the chassis due to this momentum. For example, when a wheel travels over a bump in a road surface, the wheel is provided with momentum in the vertical direction and part of this is transferred to the chassis. As the wheel reaches the top of the bump the chassis continues to travel vertically upwards due to its momentum, however the wheel begins to move downward. Hence the chassis and the wheel are now moving in opposite directions. At this point, the damper activates as it detects that the chassis and wheel are moving in opposite directions. The activation of the damper limits the overshoot of the chassis. According to the embodiment the damping output activates the damper from a residual damping state to a full required damping state within five milliseconds on detection of a vertical acceleration of the chassis which requires damping or from a full damping state to a residual damping state within five milliseconds of detection of cessation of the vertical acceleration.

According to a second embodiment of the invention the controller is associated with a gyroscopic sensor which serves to provide a datum horizontal plane from which the attitude of the chassis can be set. According to a variation of the second embodiment the datum plane is capable of being varied by adjustment of the gyroscopic sensor.

Throughout the specification, unless the context requires otherwise, the word “comprise” or variations such as “comprises” or “comprising”, will be understood to imply the inclusion of a stated integer or group of integers but not the exclusion of any other integer or group of integers.

It should be appreciated that the scope of the invention need not be limited to the particular scope of the embodiments described above.

1. A vehicle suspension control for a vehicle in which each wheel is supported from the chassis of the vehicle through a fluid operated extension element which can control a degree of relative displacement between the wheel and the chassis, the extension element enabling the resilient relative movement between the vehicle and chassis said control comprising:
a controller;
a plurality of sensors associated with each wheel of the vehicle;
a fluid flow controller comprising a fluid flow delivery means and a fluid exhaust means associated with each extension element;
a first sensor adapted to sense the relative position between the wheel and the chassis and provide a first output tot the controller;
a second sensor adapted to sense the pressure of the fluid in each extension element and provide a second output to the controller;
the controller adapted to receive the output from each of the sensors at each wheel, process the outputs and provide a wheel output to the fluid flow controller for each wheel to control the delivery of fluid or the exhaustion of fluid from respective extension element whereby the fluid pressure within each extension element is varied in order that the force applied by the extension elements between the chassis and wheels will maintain the attitude of the chassis substantially constant relative to a plane.

2. A vehicle suspension control for a vehicle as claimed at claim 1 wherein the plane comprises the general plane of the ground being traversed.

3. A vehicle suspension control for a vehicle as claimed at claim 1 wherein the wheel output for each wheel comprises a signal derived from the first output of each of the sensors of the respective wheel together with the first output from the sensors of adjacent wheels.

4. A vehicle suspension control for a vehicle as claimed at claim 3 wherein the adjacent wheels comprise a wheel which is most adjacent along the transverse axis of the chassis and a wheel which is most adjacent along a longitudinal axis of the chassis.

5. A vehicle suspension control for a vehicle as claimed at claim 1 further comprising a third sensor mounted to the vehicle and which is adapted to provide a third output which is representative of the movement of the chassis in the vertical sense over the ground relative to free space.

6. A vehicle suspension control for a vehicle as claimed at claim 5 further comprising a fourth sensor adapted to provide a fourth output representative of the lateral acceleration of the chassis.

7. A vehicle suspension control for a vehicle as claimed at claim 5 further comprising a fifth sensor adapted to provide a fifth output representative of the steering angle of the steering wheels.

8. A vehicle suspension control for a vehicle as claimed at claim 5 further comprising a sixth sensor adapted to provide a sixth output representative of the speed of the chassis over the ground.

9. A vehicle suspension control for a vehicle as claimed at claim 1 the wheel output signal for a wheel comprises a summation of the first output from the first sensor of the respective wheel, the first output from the first sensor of each of the adjacent wheels and the second output from the second sensor of the respective wheel.

10. (canceled)

11. A vehicle suspension control for a vehicle as claimed at claim 9 wherein the weighting applied to the first output of the respective wheel and the first output of each of the adjacent wheels is of the order of 2:1.

12. A vehicle suspension control for a vehicle as claimed at claim 9 wherein the controller includes an adjustable control connected to the controller which provides a control signal which can be adjusted to vary the weighting or bias applied to the first outputs from each of the first sensors in determining the wheel output to control the permitted degree of change in attitude of the chassis relative to the plane.

13. A vehicle suspension control for a vehicle as claimed at claim 9 wherein the summation of the first signals is biased by the control signal before the second signal is included to produce a resultant signal.

14. A vehicle suspension control for a vehicle as claimed at claim 9 wherein the weighting applied between the resultant signal and the second signal in deriving the wheel output is of the order of 10:1.

15. A vehicle suspension control for a vehicle as claimed at claim 11 wherein the adjustable control provides a control signal comprising a pitch control, a roll control and a height control component.

16. A vehicle suspension control for a vehicle as claimed at claim 14 wherein the control signal comprises a first control signal which is set to control the height of the chassis relative to the wheels.

17. A vehicle suspension control for a vehicle as claimed at claim 14 wherein the control signal comprises a second control signal which is set to control the permitted degree of roll of the chassis relative to the plane.

18. A vehicle suspension control for a vehicle as claimed at claim 15 wherein the control signal comprises a third control signal which is set to control the permitted degree of variation of pitch of the chassis relative to the plane.

19. A vehicle suspension control for a vehicle as claimed at claim 1 wherein the controller includes a gyroscopic device adapted to provide a signal indicative of the datum plane.

20. A vehicle suspension control for a vehicle as claimed at claim 1 wherein the datum plane can be varied in its inclination.

21. (canceled)

22. A damping control for a vehicle comprising a fluid operated damper between each wheel and the chassis each damper being capable of providing a variable degree of damping, each damper being controlled by a damper control, the control comprising a set of first sensors which provide a first output indicative of the relative position between the wheels and the chassis and a set of third sensors adapted to provide a third output indicative of the relative motion between the wheels and the chassis, the control further comprising a second control which receives the signal from the first and third sensors for each wheel, said second control providing a damping output to the damper control of each damper to vary the degree of damping applied by the damper in proportion to the third output wherein the signal from the third sensor is allowed or inhibited by the relative motion output of the first sensors.

23. A damping control for a vehicle as claimed at claim 21 wherein the chassis will maintain a constant attitude relative to the horizontal.

24. (canceled)

25. A vehicle suspension control as claimed at claim 1 where the first sensor, the first output, the third sensor and the third output of the vehicle suspension control comprise the first sensor, the first output, the third sensor and the third output of the damper control.

26. A suspension system for a vehicle comprising a chassis and at least front and rear axles supporting wheels for rotational movement of the wheels wherein said suspension system comprises resilient support members to provide resilient support for each of said wheels from said chassis, said resilient support members being controllable by a controller to vary relative displacement between each said wheel and said chassis and wherein said controller receives control signals from sensors operatively associated with said suspension system to provide signals indicative of relative displacement between each said wheel and said chassis and wherein in response to said signals said controller provides a control signal to each said resilient support member to thereby control said relative displacement between each said wheel and said chassis so as to maintain the attitude of said chassis substantially parallel with a plane of average axle articulation wherein said plane of average axle articulation comprises a plane bisecting an included angle formed between first and second planes wherein said first plane is a plane passing through said front axle of said vehicle and said second plane is a plane passing through said rear axle of said vehicle.

27. A suspension system for a vehicle as claimed at claim 25 wherein the control signal provided to each said resilient support member is derived from the relative displacement of a respective wheel associated with a resilient support member and relative displacement of adjacent wheels associated with adjacent resilient support members.

28. (canceled)

29. A suspension system for a vehicle as claimed at claim 25 wherein the control signal is derived from the summation of the relative displacement of a respective wheel and the displacement of adjacent wheels.

30. A suspension system for a vehicle as claimed at claim 27 wherein said respective wheel and said adjacent wheels have a weighting in the ratio of 2:1, said adjacent wheels each having said weighting of 1.

31. A suspension system for a vehicle as claimed at claim 25 wherein the system comprises at least one sensor adapted to output a lateral acceleration signal indicative of said vehicles lateral acceleration and said controller controlling said relative displacement of said wheels from said chassis in response to said lateral acceleration signal so as to compensate for chassis roll and thereby maintain said attitude of said chassis parallel with said plane of average axle articulation.

32. A suspension system for a vehicle as claimed at claim 25 wherein the system is adapted to provide vertical acceleration signals indicative of each said wheels vertical acceleration and said controller controlling said relative displacement of said wheels from said chassis in response to each said vertical acceleration so as to maintain said attitude of said chassis parallel with said plane of average axle articulation.

33. A suspension system for a vehicle as claimed at claim 25 wherein the system comprises resilient support members adapted to accommodate a fluid to provide said resilient support and the system actuates said resilient support members by supplying fluid under pressure and said system further comprises sensors to output to said controller signals derived from fluid pressure in each said resilient member and said system controlling said fluid pressure in each said resilient member to thereby maintain substantially equal pressures in each said resilient support members.

34. (canceled)

35. A suspension system for a vehicle as claimed at claim 25 wherein the relative displacement and said fluid pressure have a weighting ratio in the range of 20:1 to 5:1 where said pressure signal assumes said weighting of 1.

36. A suspension system for a vehicle as claimed at claim 32 wherein the weighting ratio is 10:1 such that the pressure signal assumes said weighting of 1.

37. (canceled)

38. A vehicle in which each wheel is supported from the chassis of the vehicle through a fluid operated extension element which can control a degree of relative displacement between the wheel and the chassis, the extension element enabling the resilient relative movement between the vehicle and chassis and a vehicle suspension control as claimed at claim 1, said vehicle suspension control being associated with the extension elements for the purpose of controlling the extension elements.

39. A vehicle in which each wheel is supported from the chassis of the vehicle through an extension element which can control a degree of relative displacement between the wheel and the chassis, the extension element enabling the resilient relative movement between the vehicle and chassis and a damper associated with each extension element, the operation of the dampers being controlled by a damping control as claimed at claim 21.

40. A vehicle having a suspension as claimed at claim 24.
